(19) United States
(12) Patent Application Publication
(10) Pub. No.: US 2006/0016109 A1
(43) Pub. Date: Jan. 26, 2006

(54) Advertising media

(76) Inventor: Maritz Georg Nicolaas, Randburg (ZA)

Correspondence Address: Richard J Gurak;Welsh & Katz, 22nd Floor, 120 South Riverside Plaza, Chicago, IL, 60606, US

(21) Appl. No.: 10/502,118

(22) PCT Filed: Jun. 11, 2003
(86) PCT No.: PCT/ZA03/00077

§ 371 Date: Jul. 21, 2004

(30) Foreign Application Priority Data
Jun. 11, 2002 (ZA) 02/4652

(51) Int. Cl. G09F 13/20

(52) U.S. Cl. 40/542

(57) ABSTRACT

A device for advertising in a darkened auditorium of a cinema, theatre, restaurant, bar or other darkened or semi-darkened place, which comprises a phosphorescent or luminescent substance on a substrate. An advertising message is displayed by having a cover sheet that is cut out to reveal the desired message. The glow of the phosphorescent or luminescent material also provides mild illumination.

### FIELD OF THE INVENTION

This invention lies in the fields of advertising and information media, that is, media or means for carrying an advertising message or information, also useful as a guide or for convenience when moving around in conditions of poor visibility. The invention is applicable in dark places or places that have poor lighting. Examples of such places are cinemas, theatres, night-clubs, bars, lounges, coffee shops, outdoor venues with slight, poor or non-existing lighting and there are others.

### BACKGROUND

Places that are dark or have poor lighting present special requirements for advertising and conveying information. An example is in cinemas and theatres, where the house lights are dimmed after the show begins. While advertising space is already occupied in the entrance and foyer and of course is projected onto the screen in cinemas, advertising within the darkened auditorium is not provided for. The seating often has cup holders for convenience of patrons, but these are not easily visible in the semi-dark, reducing their convenience.

### SUMMARY OF THE INVENTION

A means for advertising, conveying information and/or for enhanced convenience in darkened conditions in accordance with this invention, includes a means of emitting a fluorescent, phosphorescent, luminescent, bio-luminescent, photoluminescent, incandescent, or other source of visible light or illumination, or other means that will glow in the dark, provided on a substrate, preferably independent of any means of conveying power to it, that has a clamping, connection or mounting means for attachment or mounting on a convenient position or surface.

The substrate is typically a photoluminescent sheet or plate which emits light without an external electrical power supply being connected to it.

Thus, the device spatially modulates light emission from a photoluminescent plate in an esoteric pattern to create an attractive optical illusion, such as an advertisement or a decorative pattern.

Some of the light may be emitted downwardly from a rear zone of the photoluminescent sheet or plate to be reflected by a reflector configured to reflect the light angularly to the photoluminescent sheet or plate to contribute to the brightness and the optical illusion.

The reflector may be in the form of a reflector bowl located above or below the photoluminescent sheet or plate.

The photoluminescent plate or sheet may have an embedded, indented, engraved, or embossed watermark on its upper or lower surfaces or both.

In accordance with one embodiment of the invention, the substrate and clamping means are adapted for connection to a mug, bowl, bottle or cup holder. The cup holder may be one provided in an auditorium of a cinema or theatre, generally mounted on a seat arm-rest. The cup holder is used to ease drinking of a beverage, by the patron during a show. The invention not only provides an advertising or promotional message, but also conveniently indicates a position of the cup holder, in the dark or semi-dark. The visibility provided by the glow may also assist in persons moving to or from their seats in the darkened auditorium, for example.

In accordance with another embodiment of the invention, the substrate and clamping means are adapted for connection to an advertising board or placard. The advertising board may be used indoors in venues such as theatres and cinemas, or outside in areas where it is dark or where night time advertising is required.

The substrate may be provided with a surface application analogous to a printing process, spray application, vacuum or electrostatic mist application, silk screening, impregnating or any other technique of providing the source of visible light. Patterns may be conveniently provided by a die-cut cover sheet over a substrate that has the source of visible light. The cover sheet is cut to remove parts that are to be seen, blanking over other parts and the substrate is luminous or illuminated over the whole field of the substrate.

The substrate and cover sheet may each be a film or foil or similar that is placed onto a backing, the film or foil being replaceable, for example either to change an advertising message from time to time or to accommodate any tendency for the visibility to fade over time.

The substrate may be given a transparent or translucent cover, through which the visible light is viewed. This can be provided to protect the source (be it a chemical deposition or other source) of visible light from being degraded or detracted from during use of a cup holder or other surfaces by a user of the facility. A translucent cover may be given a colour cast that provides a modification of the basic visible light radiation from the substrate.

In one embodiment of the invention, the substrate comprises a flexible foil, e.g. of a suitable polymeric material, that has a contact adhesive or other means of mounting and retaining it on a surface, carrying the source of visible light, that may be placed onto a cup holder that is, for example, attached to a chair armrest. The foil may be in a shape that creates a surround or partial surround around a recess into which a cup (or the like) is placed, to be held. This has an advantage of indicating the position into which a cup has to be placed, in the dark. At the same time, according to the invention, the advertisement is displayed visibly in a darkened theatre.

In another embodiment of the invention, it includes a base that is rigid, has attachment or clamping means for attachment to a cup holder or the like, the base adapted to support the substrate. This base may have a transparent cover clipped onto it, of a kind as mentioned above.

For example, four colours can be used that are effective as a source of light.

The substrate and/or base are preferably shaped and in other respects carefully designed to satisfy ergonomic requirements and considerations. In particular, where mounted on chair arm rests, chair spacing distances are to be carefully accounted for in the design. Generally spacing between rows will be an important factor to take into consideration. Optionally right-hand and/or left-hand designs can be provided for.

### DESCRIPTION OF THE DRAWINGS

The invention will be more fully described by way of example, with reference to the accompanying drawings, in which:—

FIG. 1 is a front view of one embodiment,

FIG. 2 is a plan view from the bottom of the embodiment of FIG. 1

FIG. 3 is an isometric view of another embodiment,

FIG. 4 is an exploded view of the embodiment shown in FIG. 3,

FIG. 5 is an exploded view of an advertising board,

FIG. 6 is an exploded view of the embodiment of FIG. 3.

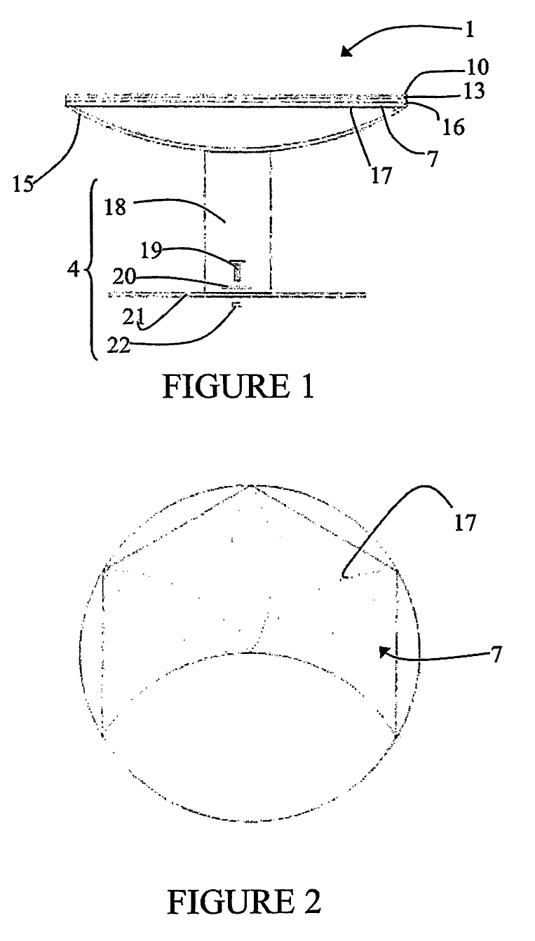

As shown in FIG. 1, the means 1 for advertising and/or for enhanced convenience in darkened conditions, includes a means of emitting a fluorescent, phosphorescent, luminescent, bio-luminescent, incandescent or other source of visible light or illumination, or other means that will glow in the dark, provided on a substrate or plate 7 which is independent of any means of conveying power to it, that has a clamping, connection or mounting means 4 for attachment or mounting on a convenient position or surface.

In this embodiment, the attachment means 4 includes a column 18, screw 19, washer 20, base 21 and nut 22.

In this case a phosphorescent paint is applied (e.g. by a silk screening process) to a substrate that is a vinyl foil similar to 7 and may be explained as a type of sticker that could be attached in the vicinity of the cup-holder and is only a vinyl foil stick on with a contact adhesive underneath, that allows mounting on the rim 12 of a cup holder (not shown) in a theatre. Extending from the rim, in this example, is a handle 11 that is covered by the part 10, also carrying the glow in the dark material. The handle 11 is attached to a chair arm-rest.

The above describes a type of sticker that could be attached in the vicinity of the cup-holder, however, for clarification purposes this is only a vinyl foil stick on and is an additional way of advertising in the vicinity of the cupholder as this is more difficult to change than the insert in the branded cupholder where the insert will rather not be vinyl but transparent foil. Typically it would rather be the cinema that will advertise for a longer term using the stick on type of advertising which is changed for example every year, it is then only a sticker that have to be removed to accommodate the new stick on advertisement ad.

A transparent logo 16 is positioned over the light emitting surface 7 and allows partial transmitting of said light.

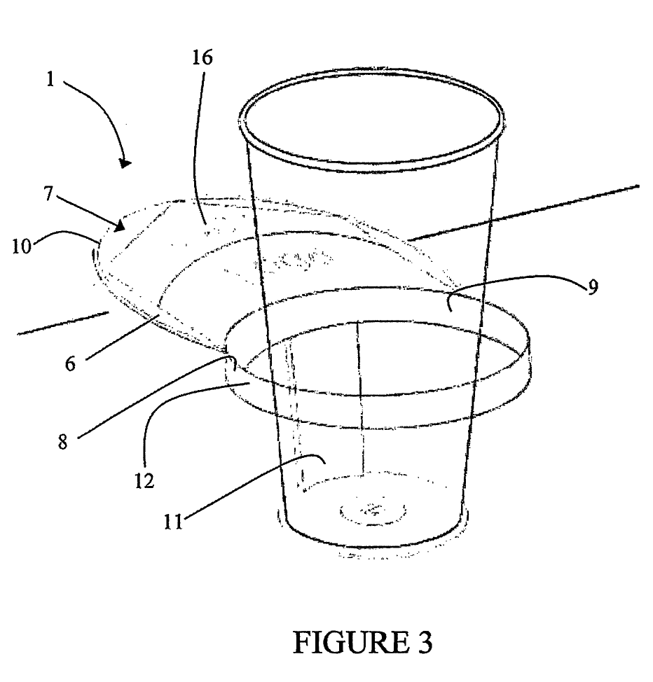

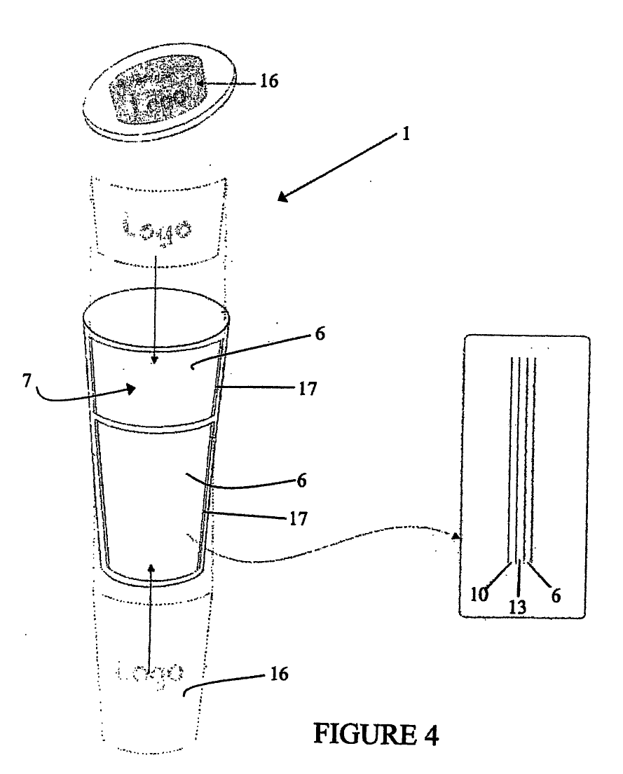

As shown in FIGS. 3, 4 and 6, the means 1 for advertising and/or for enhanced convenience in darkened conditions, includes a base insert 6 of 0.168 mm to 1 mm thickness that carries a means on its surface 7 of emitting a fluorescent, phosphorescent, luminescent, bio-luminescent, incandescent or other source of visible light or illumination, or other means that will glow in the dark, to be provided on a substrate (not shown) such as a vinyl foil, preferably independent of any means of conveying power to it, that has a connection means in the form of a ring clamp 12 joined at 8 and 9 to the base, for attachment or mounting on an arm-rest of a chair. The ring clamp 12 is in the form of a cup holder. The connection means pass into holes at 8 and 9 that receive the ring clamp. An alternative is a plastic tie that can be pulled tight around a structural feature of the arm-rest (not shown). The base 6 has a rim around its periphery that locates the foil and provides a recess to accommodate the foil. A lid 10 of transparent plastic or Perspex or polycarbonate from 0.1618 mm to 1 mm thickness is clipped over the base insert 6 after a luminescent foil 7 has been placed on to the base 6. The shape of the base is given an aesthetic aspect and an ergonomic functionality. An overlap lip or rim (not shown) is given to the cover along an arcuate part of the base insert 6 and second insert 16 that is clamped the cup holder 12. This helps ensure that it remains correctly located during use.

The cover 10 has a “letter box” type gap 10.1 of 0.1618 mm to 1 mm width provided therein into which insert 6 may be placed if desired.

The second insert 16 is from 0.168 mm to 1.618 mm thick and photoluminescent. A watermark or sign is embossed on the underside 17 of the insert 16.

The two inserts 6, 16 and the cover 10 together with the reflector bowl 15 are clipped together to form a unit.

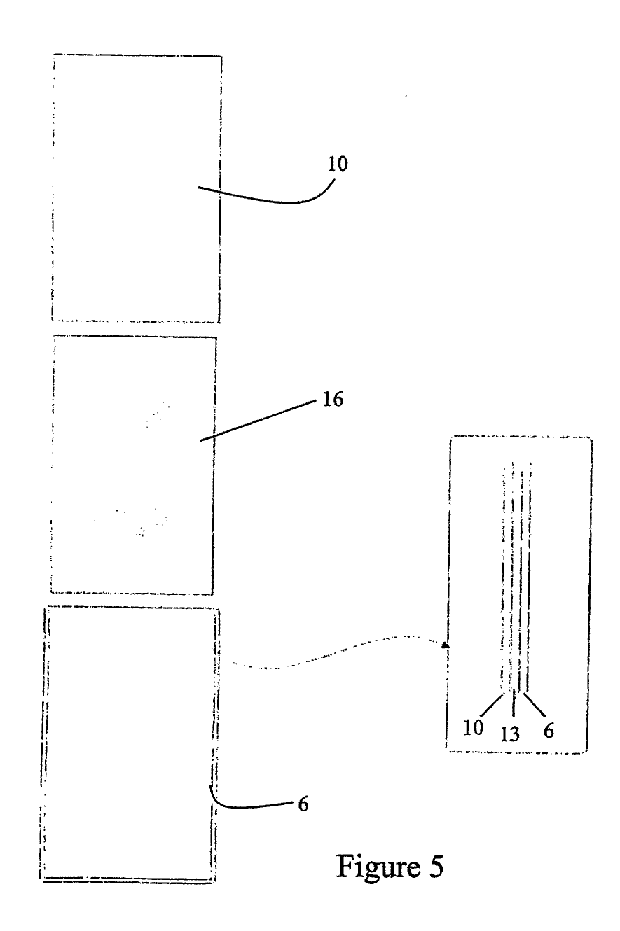

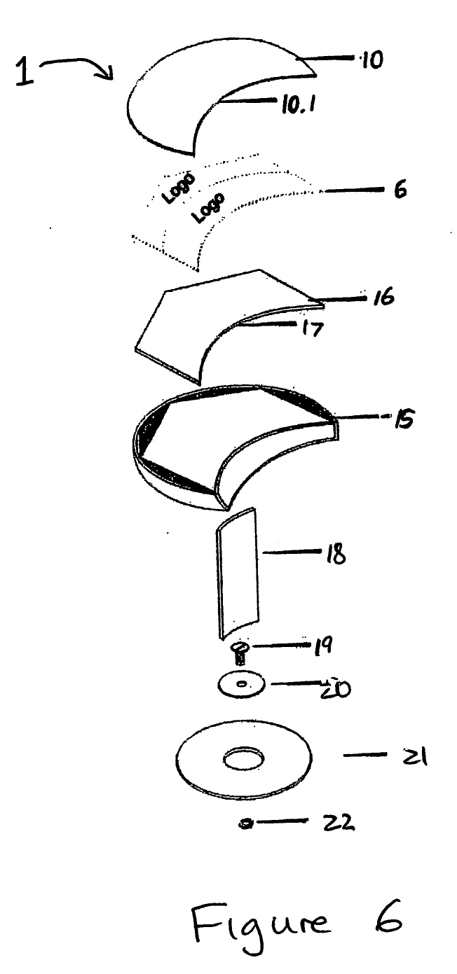

FIG. 5 shows an advertising board having a base 6 with a translucent or transparent cover (that may be tinted) 13 that covers the source of visible light that is placed on the surface of the base 6 or on a substrate that is placed on the surface of the base 6.

In FIGS. 1 to 4 some of the light will be emitted downwards from the back of the photoluminescent plate 7, to be reflected by the reflection bowl 15, back through insert 16, to contribute to brightness and the optical illusion.

The photoluminescent plate 7 may have an embedded, indented or embossed “watermark” or sign 17, (like on a coin), on its upper or lower surfaces or both.

The sign 17 is generally limited to ancient geometry, e.g. “flower of life”, star of David etc, to enhance photoluminescent therapy.

The inventor believes that the invention operates on the principles set out below, however, the inventor and the invention are not bound by current theory and the scope of the invention is as claimed.

A light source, whether visible or invisible, since most cinema theatres have only a visible cleaning light, an additional UV invisible or dark blue light may be placed in the cinema theatres and could be switched on depending on the type of luminescent materials to be activated. The UV or blue light is absorbed by fluorescence materials or by photoluminescent materials thus causing luminescence which emits visible wavelengths (Light) that appear to the human eye as a glow in certain colours of the specific activated materials.

The inventor understands the terms fluorescence and luminescence to have the following meanings:
Fluorescence is instantaneous and ceases to glow the instant the UV light is switched off; while photoluminescent material emits light when excited by a UV energy source or white light and the emission of light continues after the energy source is switched off; yet further bio-luminescence is where the light produced in a biochemical reaction involving the oxidation of a substrate via an enzyme leads to light to be emitted.
Bio-luminescence may be used in the place of Photoluminescent materials as a substitute both materials has the ability to emit visible light after the light source is removed or switched off.

The principle is here that while the product is exposed to a light source (visible or invisible) the Fluorescence material part of the advertisement transparent material inserted 16 in the product will emit light when the light source is on and when off the photoluminescent part painted on plate 7, embedded sprayed on the substrate (back plate that may be vinyl foil or Perspex) will keep on glowing in the dark. Thus having a double effect where the fluorescent material will be prominent when the UV light is on and will not emit light or glow in the dark whereby the photoluminescent material will be prominent and glow in the dark.

The fluorescence material may be printed on a transparent foil 16 that could be replaceable to change an advertising message. A major portion of the message may be printed in black that will not illuminate by fluorescence and a portion of the material may be fluorescence printed that will only emit with a UV Light lighting it up.

This transparent foil 16 may also contain a hologram or stereogram that may be activated with a UV light or only by the photoluminescent back plate 7 depending if photoluminescent or fluorescence material be used to illuminate with or without the UV Light.

The photoluminescent material will be fixed in the product as a plate 7 that may be vinyl foil or Perspex, whether painted, embedded, or sprayed on the substrate witch emits a glow in the dark effect.

The fluorescence foil 7 will always be placed on top of the photoluminescent back plate 6 in the development of the invention this back plate has a lifespan of at least 5 years.

Light is a form of electromagnetic energy that moves in measurable waves. The human eye is capable of seeing only a small segment of the spectrum known as visible light; shorter cosmic rays, gamma rays, X-rays and UV light and longer wavelengths infrared and radio waves are all invisible to humans. UV energy radiates between 180 nanometre (nm) to 400 nm wavelengths.

Natural and man-made substances can transform invisible radiated UV energy into longer, visible wavelengths that appear in a variety of colours. When UV light strikes one of these reactive substances, this energy, in the form of photons, causes each molecule to rotate violently. As the molecules slow down, they release this radiated energy in longer, now visible wavelengths that appear to the human eye as a glow in the colour of the specific activated material. This phenomenon called fluorescence, it is instantaneous and ceases the instant the UV light is removed.

Ultraviolet radiation has particular physical characteristics which affect such phenomena as luminescence and phosphorescence and is also known as fluorescence.

As the inventor understands the term, luminescence is the emission of light produced by means other than combustion such as the luminous glow of a watch dial.

As the inventor understands the term, fluorescence is the emission of light produced by certain substances when excited by a UV energy source. This emission ceases when UV source is removed.

As the inventor understands the term, phosphorescence is the emission of light produced by certain substances when excited by a UV energy source which continues after the energy source is removed.

The photoluminescent effect of pigments like light storing zinc-sulphide or Lumigen III pigments and earth-alkaline aluminium pigments or strontium aluminate phosphors are the basis of these photoluminescent pigments, whereby energy is stored and re-emitted under dark conditions over an extended period of time. Glow-in-the-dark products absorb light and then release that light over time in a process called photoluminescence. Photoluminescent material contains a chemical (example: zinc sulphide) that has the quality of storing energy when illuminated by visible light. The photoluminescent material emits light which becomes visible when the ambient light source is less effective. Without the light source to re-energize it, the photoluminescent material gives off the stored energy for a period of time with diminishing luminance.

Such products can be used over and over again, by repeatedly exposing the product to light. Pigments to be used in this photoluminescent products, will be toxicological harmless and free of radioactive additives

Bio-luminescence is the light produced in a biochemical reaction involving the oxidation of a substrate via an enzyme. This phenomenon has been used extensively in different formats for life science research and drug discovery owing to its extremely high sensitivity and non-hazardous nature

As research shows, the invention would create an alpha state for patrons looking at the space in the dark—it is like a ‘slippery glimpse’ which patrons will see as a reminder or recognition of the advertisers goodwill. Advertisers are willing to pay more for advertising mediums where they can have the trust and assurance that the onlooker will remember the essence of the message and will remember the feeling associated with a glimpse in the dark—this feeling is created by the luminescence effect.

The photoluminescent effect would have a two fold effect the first effect would be that the beverage indictor will glow for the cup placement and the next reaction should be to have a closer look as it will be a slippery glimpse, the onlooker will look closer at the advertisers slogan or logo and should in the moment of feeling good associate the advertisers message with the help of the glow in the dark indicator. The onlooker should walk away with a memory of feeling good with a subconscious memory of the picture that a moment of Alpha state has left them, the onlooker should associate that feeling again when seeing the same logo or slogan or hearing a radio ad with the same slogan message.

A further development of the invention that was tested, is to use a 3D effect such as a hologram that captures the attention span for a longer glimpse our brain always use a reference point to interpret a picture and as it has not been seen the picture before the onlooker will look closer and longer to intemperate a reference point which will be stored as a feel good memory. The 3D effect has great impact.

The most powerful effect that has been tested so far is to use a dark blue light UV light and certain colour fluorescent materials, not only will the logo be reflected in 3D if the advertiser use the effect as part of the message it could also be used in different colour effects as well. This effect can be used when the advertiser like to have this effect in synchronicity with their cinema advertisement. The effect could be triggered with the silver tape on the film before and after the time duration of the advert having a double effect as the house lights will go of and the dark blue lights will bring about a colourful fluorescent look which could be 3D or only in certain colour fluorescent materials and effects.

Experiments have also been carried out by using different lens effects i.e. a magnifying or blur or motion effect. We have also looked at lenses that use a positive and negative blur or motion effect. Some advertisers may like to use this effects where they require this effect as part of their big screen advert.

The invention can also be exited through a UV light placed in the cinema where a ultra-violet ink could be painted, silk-screened or printed on the transparent insert 2 which could be replaceable. The UV painted printed area is an extra advertisement area to the existing transparent insert that will be laser ink or jet printed in the 3 colours these pigments are used to invisibly mark banknotes, securities, cheques and credit cards under ultra-violet the marking becomes visible to the eye. The UV lamp could be triggered by an existing method in cinemas which triggers the house lights to go off or on when the main movie starts or ends. The transparent will get the existing visual effect when the luminescent back-plate is exited. The transparent insert could also be negative or positive display from the photo-luminescent back-plate.

The back-plate could also be treated with any colour emission pigment.

For the invention special kinds of luminescent pigments with selected fluorescent and photo-luminescent properties, special characteristics, optimised grain size distribution and high signal strength will be used to customize or offer a tailored marking properties for this invention.

The Chemical Composition of the Luminescent Pigments Used for the Examples of the Invention were in Accordance with the Following Specifications.

Main use: Long after glowing according to DIN 67510 part 4

Usable for: Solvent-based paints and inks, thermoplastics and thermosetting plastics.

Law/regulation Permitted by EN 71-3 (with the exception of modelling clay and finger paint) Permitted by IX.BGW in concentration _{—}10% in the endproduct.

Typical Chemical Properties

| | |
|---|---|
| Composition | alkaline earth aluminate |
| Insoluble in | alkalies, organic solvents |
| Decomposition by | water, acids |

Typical Physical Properties

| | |
|---|---|
| Appearance | yellow-green or blue or red |
| Specific gravity | 3.4 g/cm3 |
| Particle size distribution | d50 = max.28 _m as per decay curve |
| Screen analysis screen | max. 1% oversized particles on 63 _m testing |

Typical Luminescent Properties

| | |
|---|---|
| Excitation | White light, UV radiation |
| Colour of fluorescence | yellow-green or blue or red |
| Colour of phosphorescence | yellow-green or blue or red |
| Reference criterion to DIN 67510 part 1 | min 270/40-3200-W-K |

Typical Decay Curve Min Specs to be Used for the Plate 3 in the Invention.

Typical intensity of afterglow according to DIN 67510, part 1

| | | |
|---|---|---|
| After 2 minutes | 1200 | mcd/m2 |
| After 5 minutes | 550 | mcd/2 |
| After 10 minutes | 270 | mcd/2 |
| After 60 minutes | 40 | mcd/2 |
| After 120 minutes | 17 | mcd/2 |

Typical excitation of a range between 20-100% relative intensity will be exited by wavelengths from 240-480 nm. The same typical excitation of phosphorescence spectra from 420-640 nm.

Processing Instructions

As the invention displays an advertisement message, in order to prevent a reduction in brightness the crystal structure of the pigment must remain intact and not be destroyed by mechanical forces e.g. grinding or high shear forces. Contamination with metal ions will cause greying.

1. Thermoplastics and Duroplastics Injection Moulded (in Plate 3) (If not Painted on)

Only highly transparent polymers (without own body colour) will give the invention high afterglow brightness as the light emitted by pigment particles is not absorbed or scattered. Heavy metal additives may react with the afterglow pigments and reduce the brightness and thus only polymers and additives without heavy metals are suitable. In order to get luminosity of a high quality use a pre-mixed Masterbatch EVA which can be mixed with all clear thermoplastics. As a guide, the mixing ratio of Masterbatch:natural resin to achieve high afterglow-quality may be 0.55:1.

2. Synthetic Resins and Latex Paints Painted (on Plate 3, if not Moulded)

Highest brightness is obtained by using transparent binders that have a neutral pH value and without own body colour. The luminescent pigment to binder ratio is typical between 1:2 and 1:3 without heavy metal ions.

3. Screen-Printing

All afterglow and fluorescent pigments are suitable for screen printing, the correct particle size must be selected to match the mesh size of the screen, thus for the present invention crystals of a particle size greater than 250 mm should be used.

The pigments will not contain radioactive additives such as is currently found in seat and isle numbers in cinemas (Radium).

The plate 7 may be prepared by methods other than injection moulding in which case it may be brightened (not necessarily as injection moulded) with printing or silk-screening, or painted (Brush) with pigment in powder form. If prepared otherwise than by injection moulding it may be made from Masterbatch granular premix mixed with an acrylic base to reach German safety standards regulation DIN 67510. Whether injection moulded or not it must reach the standard as explained. The injection moulding is done by mixing the materials for the back plate with a clear or transparent binder and mixing it with a common agitator but not with a high shear mixer because that could destroy the crystals. The bottom side of the back plate should be painted silkscreen white as background deflection/reflection. The back plate ideally is a transparent acrylic glass and at the top the photo-luminescent material is painted/silk-screened while the bottom side remains white to provide the reflection. The rest of the holder will always be injection moulded from a transparent acrylic glass like polycarbonate or similar durable material. It could also be made in a not transparent colour but this is not ideally suited. It is only the back plate or fluorescent light that need to be in according with DIN 67510. This standard is selected because it will then guarantee a minimum standard that most cinemas will have. According to DIN 67510 there is a guarantee of a standard time that cinemas will have to allow for a min of a visibility limit of 3 mCd/m2 at a min time exposed of 5 minutes for the amount of light needed for the pigment excitement in photoluminescent backplate to display the advertisement.

In the Figures and examples the reference numerals have the following meanings.
1 advertising means
4 part of foil covering handle
6 base and transparent logo label
7 upper surface which emits light
8 hole for tie
9 hole for tie
10 clear plastic lid and/or transparent protective lens
11 handle
12 arcuate part of base clamped to cup holder (ring clamp)
13 transparent or translucent cover with gap for slide-in transparent logo
15 transparent “3d” reflection bowl
16 transparent logo (similar to 6)
17 embossed watermark or sign
18 column
19 screw
20 washer
21 base
22 nut

1-15. (canceled)

16. An advertising device for use in darkened conditions which includes a body with a luminescent material which emits a visible advertising or promotional message independently of any electrical power supply being connected thereto.

17. An advertising device according to claim 16 in which the luminescent material is more specifically a photo luminescent material.

18. An advertising device according to claim 16 which includes a clamp for attaching the body to a holder.

19. An advertising device according to claim 18 wherein the clamp, in use, is mounted on a seat arm-rest.

20. An advertising device according to claim 16 wherein the luminescent material is on a substrate which is securable to the body.

21. An advertising device according to claim 20 wherein the substrate is a flexible sheet material which is adhesively secured to the body.

22. An advertising device according to claim 20 wherein the luminescent material is applied to a surface of the substrate using a process selected from the following: a printing process; a spray application; a vacuum or electrostatic mist application; silk screening; impregnation of the substrate.

23. An advertising device according to claim 16 which includes a cover over the luminescent material through which the message is viewed.

24. An advertising device according to claim 23 wherein the cover is detachably engaged with the body.

25. An advertising device according to claim 23 wherein the cover is transparent or translucent.

26. An advertising device according to claim 25 wherein the cover is given a colour cast to modify the colour of the message.

27. A method of advertising in darkened conditions which includes the steps of storing energy in a luminescent material by exposing the material to electromagnetic radiation, and thereafter allowing the luminescent material to emit a visible advertising or promotional message in darkened conditions without an electrical power supply being connected to the material.

28. A method according to claim 27 which includes the step of placing the luminescent material on a container.

29. A method according to claim 27 which includes the step of placing the luminescent material on a holder for a container.

30. A method according to claim 27 which includes the step of placing a cover over the material to form the message.
